(19) United States
(12) Patent Application Publication
(10) Pub. No.: US 2020/0039345 A1
(43) Pub. Date: Feb. 6, 2020

(54) ACTIVE SHUTTER VANE FOR USE IN ACTIVE GRILLE SYSTEM FOR VEHICLE

(71) Applicant: BASF SE, Ludwigshafen am Rhein (DE)

(72) Inventors: Christopher Thomas KORSON, Rochester Hills, MI (US); Tushar PATEL, Canton, MI (US)

(21) Appl. No.: 16/339,898

(22) PCT Filed: Sep. 15, 2017
(86) PCT No.: PCT/US2017/051744

§ 371 Date: Apr. 5, 2019

Related U.S. Application Data
(60) Provisional application No. 62/404,485, filed on Oct. 5, 2016.

(51) Int. Cl. B60K 11/08; B60K 11/04

(52) U.S. Cl. CPC B60K 11/085; B60K 11/04

(57) ABSTRACT

An active grille system for a vehicle includes a plurality of active shutter vanes each respectively rotatably coupled to a frame portion. Each vane includes a hollow body portion having an inner and outer wall portion extending between a first and second end. The vane also includes a first solid end cap secured to the first end and a second solid end cap secured to the second end of the hollow body portion. The active shutter vane has decreased weight, increased torsional strength and increased bending rigidity as compared with active shutter vanes of the same shape and size and having a one-piece solid construction formed by injection molding process. Moreover, the use of extrusion or pultrusion to form the hollow body portion reduces warpage associated with one-piece solid construction active shutter vanes formed by injection molding process.

### CROSS-REFERENCE TO RELATED APPLICATIONS

This application claims priority to U.S. Provisional Application No. 62/404,485, filed on Oct. 5, 2016, the content of which is incorporated herein by reference.

### BACKGROUND OF THE INVENTION

### 1. Field of the Invention

The subject invention generally relates to active grille systems used in heating and cooling systems for vehicles, and more specifically to active shutter vanes for use in these active grille systems.

### 2. Description of the Related Art

Automotive active grille systems (sometimes alternatively referred to as active grille shutters) are positioned in front of automotive radiators. These systems include a plurality of active shutter vanes that are independently coupled to a frame portion and are each individually and collectively rotatable relative to the frame portion between an open position, a partially open position, and closed position. In the open position, each of the active shutter vanes are positioned to allow maximum air flow from outside the vehicle to the radiator, relative to the partially open and closed position, to cool the radiator. As the multiple vanes are rotated from the open position to the partially open position and closed position, the relative amount air flow through the multiple vanes correspondingly decreases, but wherein the aerodynamics to the front of the vehicle may be increased. Thus, by controlling the relative position of the multiple vanes from an open position, a partially opened position, and closed position, improvements to the aerodynamics of the vehicle and to the control of the heating and cooling of the underhood components, including the radiator, may be realized.

Historically, the active shutter vanes utilized in the active grille systems are formed as solid pieces from unfilled and fiber reinforced plastic materials (typically thermoplastic materials) such as polyamides, typically utilizing an injection molding process. However, such solid plastic materials are known to suffer from warpage resulting from the injection molding process. Moreover, such solid piece designs are heavy and require specialized injection molds sized to match the outer profile for the vanes for a particular application. In other words, a different mold or mold cavity must be used for producing each vane having a different size or shape, and the costs for such additional molding correspondingly increases. In addition, vanes produced in injection molds have limited bending deflection, which is critical for blocking air flow. Still further, solid vanes produced in injection molds have limited torsional strength. Such torsional strength may be necessary to substantially prevent or minimize the possibility of breakage as the vanes are rotated, particularly when ice jams or mud jams are present within the vanes.

The present invention addresses many of the issues for active grille systems which utilize solid, one-piece active shutter vanes, including those formed via an injection molding process.

### SUMMARY OF THE INVENTION AND ADVANTAGES

The present invention provides an active grille system for a vehicle having a radiator that includes a plurality of active shutter vanes each respectively rotatably coupled to the frame portion.

Each active shutter vane includes a hollow body portion having an inner wall portion and an outer wall portion extending between a first end and a second end. The inner wall portion defines at least one cavity extending from the first end to the second end, while the inner wall portion and the outer wall portion define a first edge at the first end and a second edge at the second end. The active shutter vane also includes a first solid end cap secured to the first end of said hollow body portion and a second solid end cap secured to a second end of the hollow body portion. The hollow body portion is formed from a first plastic material, while the first and second end caps are each formed from a second plastic material that is the same as or different from the first plastic material.

In further embodiments, the active grille system includes an actuator assembly coupled to the plurality of active shutter vanes for coordinating the rotation of each one of the respective plurality of active shutter vanes relative to frame portion from an open position, to a partially open position, and to a closed position.

Still further, the present invention provides a method for forming the active shutter vane used in the active grille system that includes extruding or pultruding a hollow body portion from a first plastic material, the hollow body portion having an inner wall portion and an outer wall portion extending between a first end and a second end, the inner wall portion defining at least one cavity extending from the first end to the second end, the inner wall portion and the outer wall portion defining a first edge at the first end and a second edge at the second end. Next, a first solid end cap and a second solid end cap are formed from a second material that is the same or different from the first plastic material. Next the first solid end cap and the second solid end caps are secured to the first end and the second end, respectively, of the hollow body portion.

Yet still further, the active shutter vanes formed above may also be used to form an active grille system for a vehicle. For forming the active grille system, the method further includes providing a frame portion comprising a pair of frame sections spaced from each other; coupling the first solid end cap to one of the pair of frame sections and coupling the second solid end cap to an other one of the pair of frame sections such that the active shutter vane is rotatable relative to the frame portion. Even still further, the active shutter vanes may also be coupled to an actuator system for coordinating the rotation of the active shutter vanes relative to frame portion from an open position, to a partially open position, and to a closed position

The active shutter vanes, and the associated automotive active grille systems and methods for making the active shutter vanes, offers many advantages in terms of manufacturing ease, reduced costs, and increased performance as compared with active shutter vanes formed as a single solid piece in an injection molding process. For example, the active shutter vanes of the present invention have reduced weight and increased torsional and bending rigidity as compared with active shutter vanes formed as a single solid plastic part of the same general design. Still further, the use of an extrusion or pultrusion process to form the hollow body portion eliminates warpage that results from molding solid body parts of the same general design. Moreover, extruded or pultruded hollow body parts can be formed in a single pultruder or extruder and can subsequently be easily be cut to a desired length, thus reducing capital costs associated with tooling requirements to form each individually sized vane.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a portion of a vehicle including an active grille system in accordance with one embodiment of the present invention;

FIG. 2 is a perspective view of the active grille system of FIG. 1 in an open position;

FIG. 3 is a perspective view of the active grille system of FIG. 1 in a closed position;

FIG. 4 is a perspective view of an active grille vane having a hollow body portion and a pair of solid end caps in accordance with one embodiment of the present invention;

FIG. 5A is a section view of the hollow body portion of the active grille vane of FIG. 4 taken along line 5A-5A in accordance with one embodiment of the present invention having a closed section profile;

FIG. 5B is a right side view of FIG. 5A;

FIG. 5C is a section view of the hollow body portion of the active grille vane of FIG. 4 taken along line 5C-5C in accordance with another embodiment of the present invention having an open section profile (the open section profile not being shown in FIG. 4);

FIG. 5D is a right side view of FIG. 5C;

FIG. 6A is a section view of the hollow body portion of the active grille vane of FIG. 4 taken along line 6A-6A in accordance with another embodiment of the present invention;

FIG. 6B is a right side view of FIG. 6A;

FIG. 7 is a perspective view of one of the solid end caps of FIG. 4 in accordance with one embodiment of the present invention prior to the solid end cap being secured to the hollow body portion;

FIG. 8 is a perspective view of the solid end cap of FIG. 7 after the solid end cap has been secured to the hollow body portion;

FIG. 9 is a perspective view of one of the solid end caps of FIG. 4 in accordance with another embodiment of the present invention prior to the solid end cap being secured to the hollow body portion;

FIG. 10 is a perspective view of the solid end cap of FIG. 9 after the solid end cap has been secured to the hollow body portion;

FIG. 11 is a perspective view of one of the solid end caps of FIG. 4 in accordance with yet another embodiment of the present invention prior to the solid end cap being secured to the hollow body portion;

FIG. 12 is a perspective view of the solid end cap of FIG. 10 after the solid end cap has been secured to the hollow body portion;

FIG. 13 is a perspective view of one of the solid end caps of FIG. 4 in accordance with still another embodiment of the present invention prior to the solid end cap being secured to the hollow body portion;

FIG. 14 is a perspective view of the solid end cap of FIG. 13 after the solid end cap has been secured to the hollow body portion through the use of an adhesive;

FIG. 15 is a perspective view of the solid end cap of FIG. 13 after the solid end cap has been secured to the hollow body portion through sonic welding;

FIG. 16 is a perspective view of an outer end of the solid end cap illustrated in any one of FIGS. 7-15; and

FIG. 17 is a perspective partial view of the active grille system including a plurality of vanes coupled to a frame portion and an actuator assembly in accordance with one embodiment of the present invention.

### DETAILED DESCRIPTION OF THE INVENTION

Referring to the Figures, wherein like numerals indicate corresponding parts throughout the several views, the present invention is directed to active shutter vanes 30 and a method for forming the respective active shutter vanes 30. The present invention is also directed to the use of these active shutter vanes 30 in an active grille system 25 for a vehicle 20. Still further, the present invention is directed to the vehicle 20 that includes the active grille system 25 that is positioned adjacent to the radiator 40 of the vehicle 20 such that the one or more active shutter vanes 30 are located between the radiator 40 and the outside of the vehicle 20.

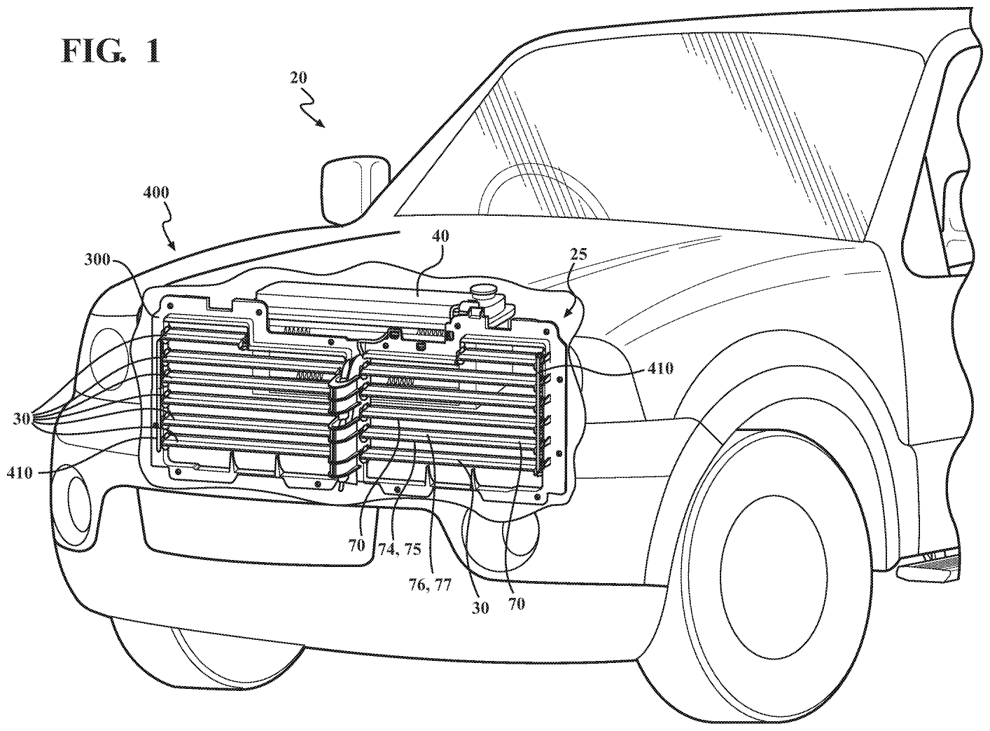

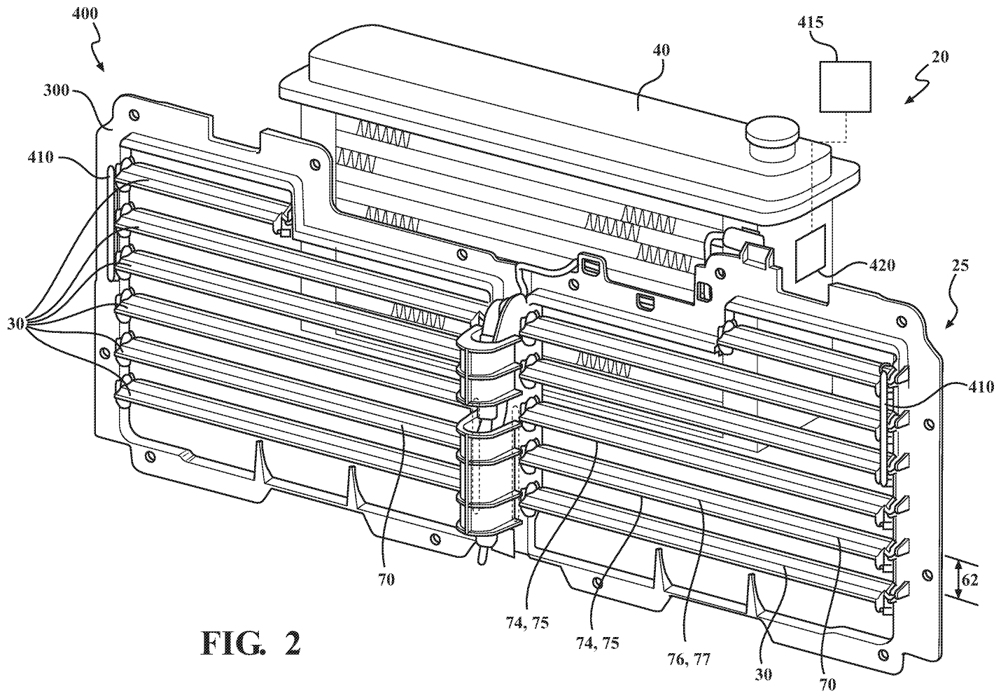

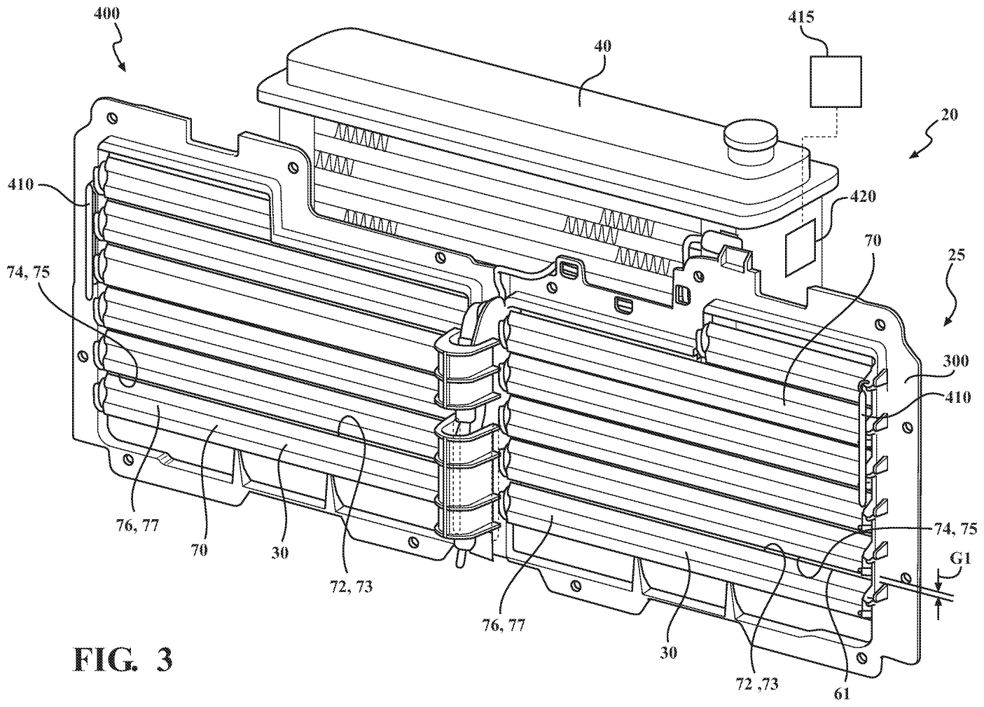

As best shown in FIGS. 1-3, the active grille system 25 includes a plurality of active shutter vanes 30 individually and rotatably coupled to a frame portion 300. In addition, the active grille system 25 includes an actuator assembly 400 that is coupled to each of the plurality of active shutter vanes 30 and optionally to the frame portion 300. The actuator assembly 400 coordinates the rotation of the plurality of active shutter vanes 30 from an open position (as shown in FIG. 2) to a closed position (as shown in FIG. 3), and also from a closed position to an open position, to control the amount of air flow to the radiator 40 as the vehicle 20 is moving. The open position allows a maximum amount of air flow between each respective pair of adjacent vanes 30 to the radiator 40 as the vehicle 20 is moving, while the closed position that allows a minimum amount of air flow between each respective pair of adjacent vanes 30 to the radiator 40 as the vehicle 20 is moving. While not shown, actuator assembly 400 also controls the rotation of the active shutter vanes 30 to a partially open position between the open and closed position, in which the air flow between each adjacent pair of vanes 30 to the radiator 40 is between the maximum and minimum air flow as the vehicle 20 is moving.

Yet still further, in other embodiments, the actuator assembly 400 may coordinate the rotation of individual or groups of the active shutter vanes 30 such that collectively the group of active shutter vanes 30 are in the partially open position, which allows less than the maximum and greater than the minimum air flow from the outside of the vehicle through the vanes 30 to the radiator 40 as the vehicle 20 is moving. Thus, for example, the partially open position may be defined in one instance wherein a pair of adjacent shutter vanes 30 are placed in a position that allows maximum air flow between the respective pair of shutter vanes, but wherein the next adjacent shutter vane relative to one of the shutter vanes is positioned such that less than the maximum amount of air flow between one of the pair of adjacent shutter vanes 30 and this next adjacent vane 30. Alternatively, the partially open position may be defined wherein all of the vanes are rotated to a position wherein the amount of air flowing between each adjacent pair of vanes is consistent but wherein the amount is less than the maximum, yet greater than the minimum, amount of air that flows to the radiator 40 as the vehicle 20 when compared to the amount of air flow in the open or closed position.

The method for controlling the positioning of each adjacent pair of the active shutter vanes 30 using the actuator assembly 400 is not considered a part of the inventive aspect of this invention.

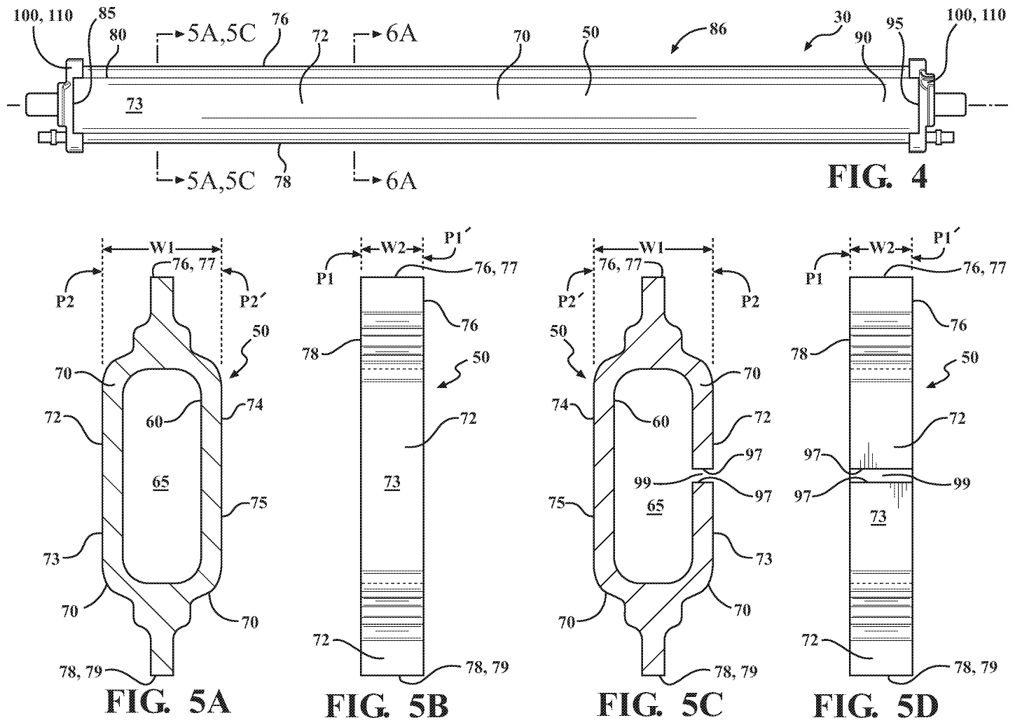

As best shown in FIG. 4, each active shutter vane 30 includes a hollow body portion 50 and a pair of solid end caps 100, 110, wherein a respective one of the pair of solid end caps 100 or 110 is secured to a first end 80 of the hollow body portion 50 and wherein the respective other one of the pair of solid end caps 100 or 110 is secured to a second end 90 of the hollow body portion 50.

As shown best in FIGS. 4-6, the hollow body portion 50 has an inner wall portion 60 and an outer wall portion 70 extending between a first end 80 and a second end 90. The inner wall portion 60 and the outer wall portion 70 collectively define a first edge 85 at the first end 80 and a second edge 95 at the second end 90 of the hollow body portion 50. The outer wall portion 70 and the first and second edge 85, 95 collectively define an outer profile 86.

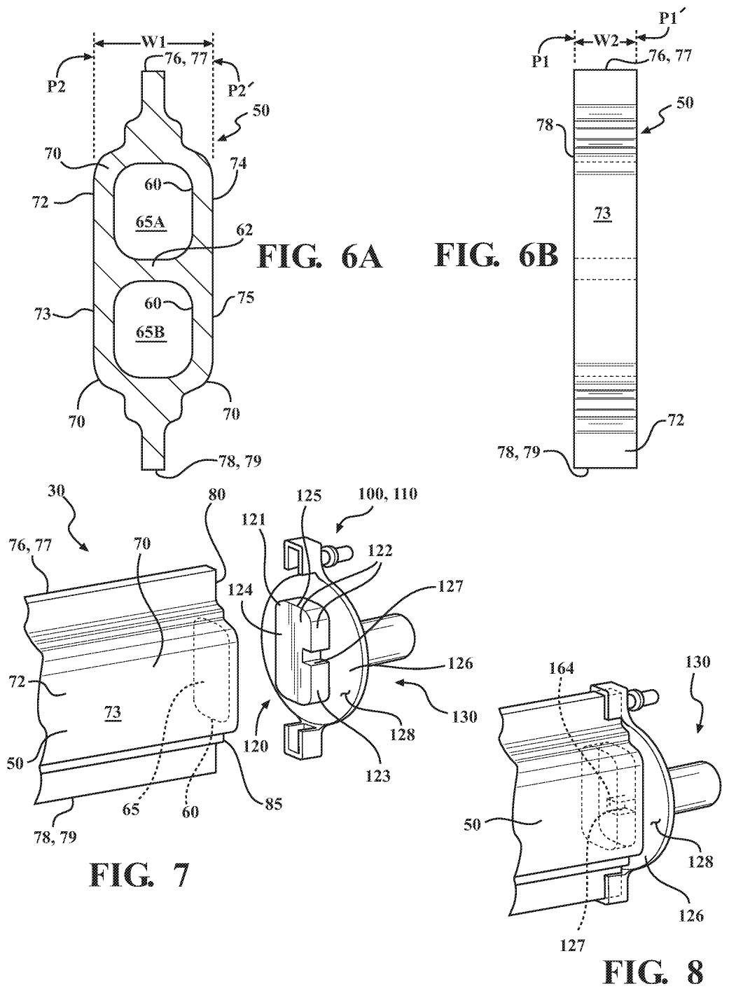

The inner wall portion 60 also defines at least one cavity 65 extending from the first end 80 to the second end 90. As shown in FIGS. 5A-5D, the inner wall portion 60 defines a single cavity portion 65. In certain embodiments, such as shown in FIGS. 6A and 6B, the inner wall portion 60 may include one or more rib portions 62 extending from the first end 80 to the second end 90 that subdivides the cavity 65 into two or more cavity portions (shown in FIGS. 6A and 6B as two cavity portions 65A and 65B).

As best shown in FIGS. 5A, 5B, 5C, 5D, 6A and 6B, the outer wall portion 70 of each active shutter vane 30 includes a pair of opposing first side portions 72, 74 spaced apart from each other and connected to each other by a respective pair of opposing second side portions 76, 78. Each of the opposing first side portions 72, 74 defines a width W1 measured between planes P2, P2′; with planes P2, P2′ defined along the outer surface 73, 75 of the respective first side portions 72, 74. Similarly, each of the opposing second side portions 76, 78 defines a width W2 measured between planes P1, P1′; with planes P1, P1′ defined along the outer surface 77, 79 of the respective second side portions 76, 78. Preferably, the width W1 of the respective first side portions 72, 74 is greater than the width W2 of the respective second side portions 76, 78.

Accordingly, when the active shutter vanes 30 are rotatably coupled to the frame portion 300 of the active grille system 25, and wherein the active grille system 25 is in the closed position, as shown in FIG. 3, each of the active shutter vanes 30 are positioned (i.e., rotated to a defined closed position) such that side portion 72, 73 of one vane 30 is adjacent to the side portion 74, 75 of the next adjacent vane 30 and such that the outer surface 77 of the side portion 76 of each of the adjacent vanes 30 is substantially coplanar along Plane P1 (as is the corresponding outer surfaces 79 of the opposing second side portion 78 of each of the vanes 30, which are substantially coplanar along Plane P1′). In this closed position, the gap G1 (see FIG. 3) between each respective pair of the adjacent vanes 30, as defined by the distance between the outer surface 70 of each respective pair of vanes 30, is at a minimum.

By contrast, in the open position, as shown in FIGS. 1 and 2, each adjacent pair of active shutter vanes 30 are positioned (i.e., rotated to a defined open position) such that the second side portion 76, 77 of one of the two adjacent vanes 30 is adjacent to the second side portion 78, 79 of the next adjacent vane 30 and such that the outer surface 75 of the side portion 74 of each of the vanes 30 is substantially coplanar along Plane P2′ (as is the outer surface 73 of the opposing side portion 72, which are substantially coplanar along Plane P2). In this open position, the gap G2 (see FIG. 2) between each respective pair of the adjacent vanes 30, as defined by the distance between the outer surface 70 of each respective pair of vanes 30, is at a minimum. However, in this open position, the gap G2 is always greater than the gap G1 by virtue of the fact that the width W2 is always shorter than the width W1.

As noted above, the active shutter vanes 30 may also be rotated to a position between the open position of FIGS. 1-2 and the closed position of FIG. 3—also referred to as a partially open position. As noted above, the partially open position may be defined in a wide variety of ways. However, the partially open position may alternatively be defined wherein the gap between at any two adjacent vanes 30 is greater than the minimum gap G1 and less than the maximum gap G2.

In certain embodiments, as shown in FIGS. 5A, 5B, 6A and 6B, each of the cavities 65 and cavity portions 65A, 65B are considered closed, in that the respective inner wall portion 60 of the respective cavity 65 or cavity portions 65A and 65 is continuous between the first end 80 and the second end 90 (and wherein the outer wall portion 70 is also continuous between the first end 80 and the second end 90). Alternatively, such as shown in FIG. 5C (FIG. 5C is described as a section view of FIG. 4, but wherein FIG. 4 includes an open section profile not illustrated in the attached FIGS. 4) and 5D, the cavity 65 in hollow body portions 50 having a single cavity (i.e., without a rib portion 62) may be open (i.e., it has a open section profile), wherein a pair of opposing inlet portion 97 extends between the inner wall portion 60 and the outer wall portion 70 of the hollow body portion 50 and define a channel 99 there between that is partially defined by the respective cavity 65 or one of the respective cavity portions 65A or 65B. In other words, the inner wall portion 60 and outer wall portion 70 terminate into the respective opposing inlet portions 97, which connect the inner wall portion 60 and outer wall portions 70. As shown in one embodiment in FIGS. 5C and 5D, the opposing inlet portions 97 are located within one of the opposing first side portions 74 and thus the channel 99 extends from the outer wall portion 70 of the first side portion 74 to the inner wall portion 60 and to the cavity 65, and as such the cross-section of the hollow body portion 50 defines a c-shape. In other embodiments (not shown) having one cavity 65, the opposing inlet portions 97 could alternatively be formed within the other of the opposing first side portions 72, or in one or the other of the second side portions 76, 78, and still define an open cavity 65. Even still further, the opposing inlet portions 97 may also define a channel 99 extending from the outer wall portion 70 to the inner wall portion 60 and to one or more of the respective cavity portions in embodiments having two or more cavity portions separated by respective rib portions 62 (such as cavity portions 65A, 65B in FIGS. 6A and 6B). In any of these embodiments, the gap between the opposing inlet portions 97 defining the channel 99 is small such that the hollow body portion 50 can be considered hollow between the first end 80 and the second end 90 and not just open between the first end 80 and second end 90.

The hollow body portion 50, in certain embodiments, may be formed from a first plastic material. Exemplary plastic materials that may be used polymeric materials and fiber-reinforced polymeric materials.

Exemplary polymeric materials include, include polyamides such as polyamide 6 (nylon 6), polyamide 66 (nylon 6, 6), polybutylene terephthalate (PBT), polyethylene terephthalate (PET), thermoplastic polyolefins (TPO), and polypolypropylene (PP).

Exemplary fiber-reinforced polymeric materials include the afore-mentioned polymeric materials mixed with fiber materials prior to processing. Suitable fibers that can be used include short fibers such as e-glass or longer fibers. When utilized, the fiber content in the fiber-reinforced polymeric materials is typically between 5 and 60 percent of the total weight of the fiber-reinforced polymeric material.

Preferably, the hollow body portion 50 is formed by an extrusion or pultrusion process.

In an extrusion process, the polymeric material (as described above and in the form of strands, pellets, or granules optionally mixed with other materials such as catalysts) is fed and heated inside an extruder until the polymeric material is melted. The melted polymeric material is forced (pushed) through a die to form profiles with a consistent cross-sectional shape. Accordingly, as the melted polymeric material is forced through the die, it cools and optionally cures to form a hardened part of continuous length and having a constant cross-sectional profile corresponding to the inner and outer profile of the inner wall portion 60 and outer wall portion 70 of the hollowed body portion 50. After exiting the die, the hardened continuous plastic part may be cut to the desired length corresponding to the length between the first and second end 80, 90 as defined by the respective first and second edges 85, 95.

As opposed to the extrusion process, which pushes the melted polymeric material through a die, a pultrusion process pulls plastic or polymeric materials through a die using an external puller. In the pultrusion process, a reinforcement material such as fiberglass or other glass fibers, in the form of rolls or mats, are pulled through a heated forming die using a continuous pulling device and saturated with a liquid resin material. The liquid resin material, which may be the polymeric material as described above in the extrusion process, saturates the fibers of the fiber reinforcement material as it is pulled through the heated forming die. As the coated reinforcement material is pulled outward from the die, the liquid resin material cools and optionally cures onto the fiber reinforcement material to form a hardened part of continuous length and having a constant cross-sectional profile corresponding to the inner and outer profile of the inner wall portion 60 and outer wall portion 70 of the hollowed body portion 50. Similar to the extruded hardened continuous plastic part, the pultruded hardened continuous plastic part may be cut to the desired length corresponding to the length between the first and second end 80, 90 as defined by the respective first and second edges 85, 95 to form the hollow body portion 50.

As also noted above, the active shutter vane 30 of each of the exemplary embodiments includes a first solid end cap 100 secured to the first end 80 of the hollow body portion 50 and a second solid end cap 110 secured to the second end 90 of the hollow body portion 50.

In general terms, as shown in the respective figures, each of the solid end caps 100, 110 has an inner end 120 that is shaped and sized to be secured to the respective first end 80 or second end 90 of the hollow body portion 50. In addition, each of the solid end caps 100, 110 has an outer end 130 that is shaped and sized to be rotatably coupled to the plastic frame 300 and individually coupled to the actuator assembly 400.

The relative size and shape of the inner end 120 of the respective solid end cap 100, 110 depends upon numerous factors, including but not limited to the size and shape of the first or second end 80, 90 of the hollow body portion 50 to which the inner end 120 of the solid end cap 100, 110 is to be secured. In addition, the size and shape of the inner end 120 is also dependent upon the method by which the inner end 120 is to be secured to the respective solid end cap 100, 110.

Exemplary, non-limiting examples of the inner ends 120 of the respective solid end cap 100, 110, and their respective coupling to the first or second end 80, 90 of the hollow body portion 50, are illustrated in FIGS. 7-16 below. For illustrative purposes hereinafter, the solid end cap in each of the FIGS. 7-16 and in the description below refers to the solid end cap 100, but it is to be appreciated that solid end cap 110 may have a similar configuration for its inner end 120 as the solid end cap 100. Also, the securing of the solid end cap 100 is illustrated in FIGS. 7-13 at the first end 80 of the hollow body portion 30, although the solid end caps 100 or 110 can be secured to the hollow body portion 30 at the second end 90 by the same methods.

Referring first to FIGS. 7 and 8, a solid end cap 100 in accordance with one exemplary embodiment is formed in which the inner end 120 includes an inner projection 121 having an outer surface 122. The outer surface 122 of the inner projection 121 is generally shaped to correspond to the size and shape of the inner wall portion 60 extending between the first end 80 and the second end 90. Accordingly, the outer surface 122 includes a side region 123 and an end region 124 with an edge portion 125 defined as the transition between the side region 123 and end region 124. The side region 123 terminates into a wall 126 that extends generally normal to the outer surface 122 of the side region 123. The outer surface 122 of the side region 123 includes one or more channels 127 extending from the edge portion 125 towards the wall 126.

To secure the solid end cap 100 to the first end 80 of the hollow body portion 50, as shown best in FIG. 8, the inner projection 121 is inserted within the cavity portion 65 as the first end 80 such that the outer surface 122 of the side region 123 is adjacent to the inner wall portion 60. The insertion proceeds until the inner surface 128 of the wall 126 is adjacent to the first edge 85 of the first end 80. An adhesive 164 is included within the channel 127, and therefore bonds the inner projection 121 to inner wall portion 60, thereby securing the solid end cap 100 to the first end 80 of the hollow body portion 50.

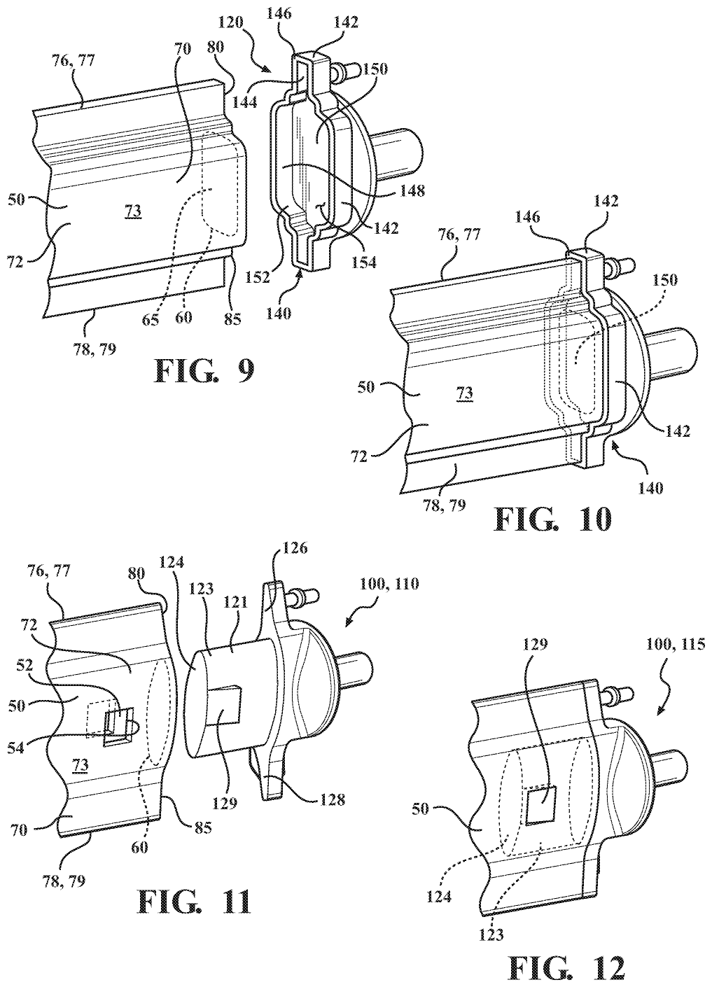

In an alternative configuration, as illustrated in FIGS. 9-10, the inner end 120 of the solid end cap 100 is formed as having an outer projection 140 having an outer wall portion 141 connected to an inner wall portion 142 via an edge portion 143. The inner wall portion 143 includes a side region 144 and a rearward region 145. The side region 144 has an inner surface 146, and the rearward region 145 has an inner surface 147.

Still further, the inner surface 146 of the side region 144 is shaped to define an inner profile 148 correspond to the size and shape of the outer surface 70 of the hollow body portion 50 defined by the outer profile 86, but wherein the dimensions are slightly larger than the outer profile 86. Yet still further, the inner surface 146 may include one or more angled detents 149.

To secure the solid end cap 100 to the first end 80 of the hollow body portion 50, as shown best in FIG. 10, the outer projection 140 is inserted over the first end 80 of the hollow body portion such that the inner profile 148 of the solid end cap 100 is adjacent to a portion of the outer profile 86 of the hollow body region 30 and such that inner surface 146 is adjacent to the edge 85 of the hollow body portion.

Referring first to FIGS. 11 and 12, a solid end cap 100 in yet another exemplary embodiment is formed in which the inner end 120 includes an inner projection 121 having an outer surface 122. The outer surface 122 of the inner projection 121 is generally shaped to correspond to the size and shape of the inner wall portion 60 extending between the first end 80 and the second end 90. Accordingly, the outer surface 122 includes a side region 123 and an end region 124 with an edge portion 125 defined as the transition between the side region 123 and end region 124. The side region 123 terminates into a wall 126 that extends generally normal to the outer surface 122 of the side region 123. As opposed to a channel 127 as in the solid end cap 100 of FIG. 7, the outer surface 122 of the side region 123 includes one or more angled detents 129, or ramps, extending from the edge portion 125 towards the wall 126.

To secure the solid end cap 100 to the first end 80 of the hollow body portion 50, as shown best in FIG. 12, the inner projection 121 is inserted within the cavity portion 60 as the first end 80 such that the outer surface 122 of each of the one or more angled detents 127 is resiliently engaged to the inner wall portion 60. The insertion proceeds until the inner surface 128 of the wall 127 is adjacent to the first edge 85 of the first end 80.

Optionally, and as shown in FIGS. 11 and 12, the hollow body portion 50 may include a receiving orifice 52 that accepts and retains the detent 127 when the insertion is complete such that the inner surface 128 of the wall 127 is adjacent to the first edge 85 of the first end 80. The receiving orifice 52 is defined by an inner surface 54 extending through the hollow body portion 50 from the inner wall portion 60 to the outer wall portion 70 between the first and second end 80, 90.

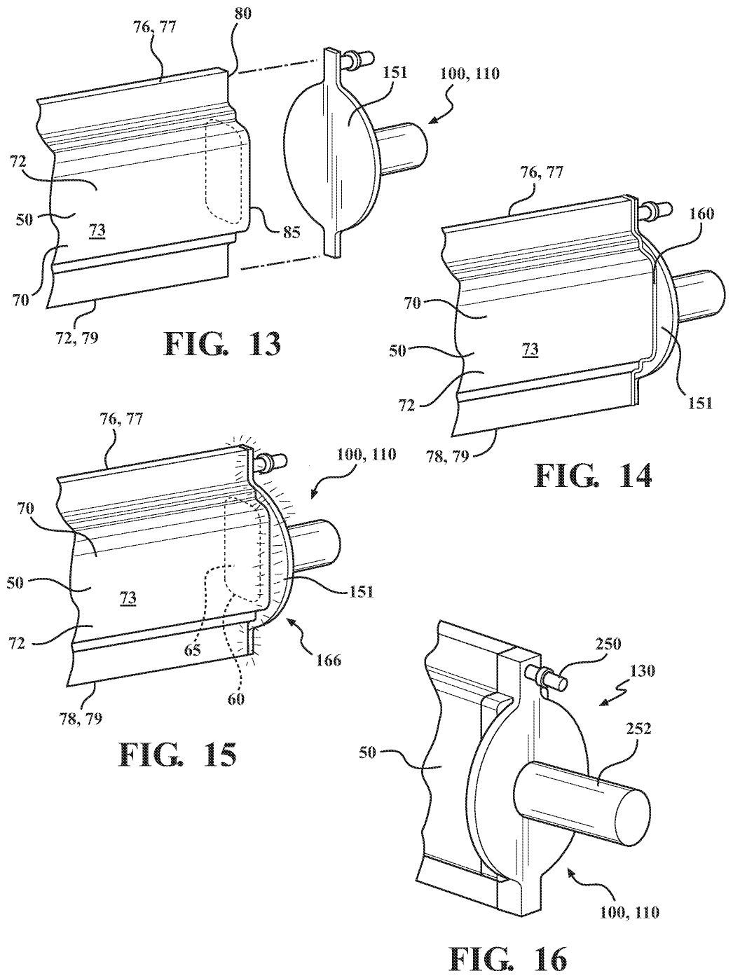

In yet another alternative configuration, as illustrated in FIGS. 13-14, the inner end 120 of the end cap 100 includes edge surface 151 that is sized and shaped to correspond to the edge 85 of the first end 80, or to the edge 95 of the second end 90, of the hollow body portion 50 (illustrated in FIG. 12 has corresponding to the edge 85 of the first end 80).

To secure the solid end cap 100 to the first end 80 of the hollow body portion 50, as shown best in FIG. 14, an adhesive 160 is applied to either edge surface 151 or to the edge 85 of the hollow body portion 30. Next, the edge surface 151 is positioned adjacent to the first edge 85 of the first end 80 such that the adhesive 160 is in contact with both edge surface 151 and the first edge 85 so secure the solid end cap 100 to the first end 80. A similar procedure is used to secure the edge surface 151 of the solid end cap 110 to the edge surface 95 of the second end 90, thereby securing the solid end cap 110 to the second end 90 of the hollow body portion 50 with the adhesive 160. Preferred adhesives that may be used include adhesives based on opoxy, urethane, silicon, phenolics, and cyanoacrylates that are compatible with the polymeric materials used in the hollow body portion 50 above. Exemplary commercial adhesives that could be used, depending upon the desired application, include those commercially available from 3M (Scotch Weld 2214, Jet Melt, Jet Melt 3789 and Jet Melt 3796), Delo (Monopox 6093), Dexter (Hysol 934NA and Hysol 9394), Dow Corning (EA6054), Fuller (UR 1100 and FE 6046), Hardman (Phenoweld 7), Henkel (Terokal 5046), Loctite (Superbonder 498), and Lord (Tyrite 5700 A/C).

Alternatively, as shown in FIG. 15, as opposed to using an adhesive 160, the solid end cap 100 of the embodiment of FIG. 13 may be secured to the first end 80 of the hollow body portion 50 via a friction welding process or via a sonic welding process. Accordingly, in FIG. 15, the edge surface 151 of the solid end cap 100 is friction/sonic welded to the edge 85 of the first end 80, therein creating a weld 166 at the interface between the edge surface 151 and the edge 85. A similar procedure may be used to create a friction/sonic weld 166 at the interface between the edge surface 151 and the edge 95 to secure the second solid end cap 110 to the second end 90 of the hollow body portion 50. The friction welding process or sonic welding process is a well known process for joining together plastic parts.

FIG. 16 also illustrates an exemplary embodiment for the outer end 130 of the respective solid end caps 100, 110 of the present invention that can be included with any of the inner ends 120 to form a respective solid end cap 100 or 110 in accordance with the present invention. Similar to the inner end 120, the relative size and shape of the outer end 130 is dependent upon numerous factors. For example, the relative size and shape of the outer end 130 of each one of the respective solid end caps 100, 100 is dependent upon the structure of the respective frame portion 300 to which the outer end 130 is rotatably coupled. In addition, the size and shape the outer end 130 is also dependent upon the structure of actuator assembly 400 to which it is coupled and the method by which the active shutter vanes 30 are coordinately rotated by the actuator assembly 400.

As shown in FIG. 16 with respect to the solid end cap 100 but equally applicable to the solid end cap 110, the outer end 130 includes a pin portion 250 and a pivot pin portion 252.

The first and second solid end caps 100, 110 are each formed from a second plastic material that is the same as or different from the first plastic material. Preferably, the solid end caps 100, 110 are formed by molding, and more preferably by injection molding.

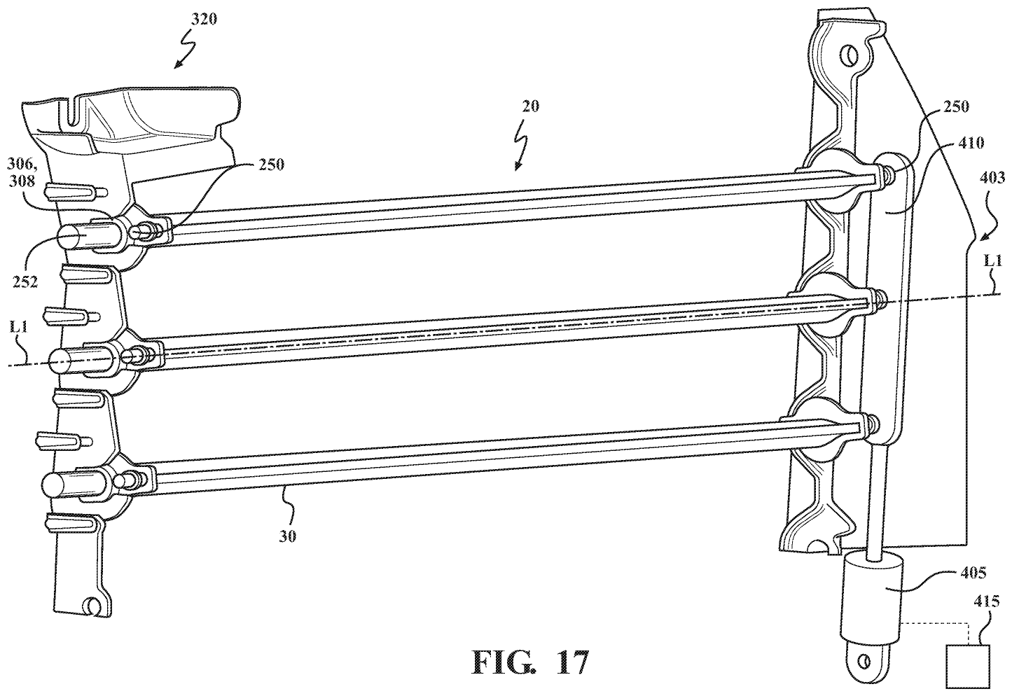

As noted above, in addition to the active shutter vanes 30 in accordance with the present invention, and as also shown in FIG. 17, the active grille system 25 also includes a frame portion 300 and an actuator assembly 400.

Referring to FIG. 17, the frame portion 300 has at least a pair of spaced apart frame sections 302, 304. Each of the frame sections 302, 304 includes and defines a plurality of spaced apart openings 306, 308 extending along their respective lengths, with the number and location of the openings 306 on the first frame section 302 being coordinated with the number and location of openings 308 on the second frame section 304 and thus define a respective coordinated pair of openings 306, 308.

Still further, also shown in FIG. 17, the actuator assembly 400 includes an actuator 405 that is coupled to one or more link bars 410. The actuator assembly 400 also typically includes a control unit 415 that controls the up and down movement of the actuator 400 (as well as the corresponding movement of the link bars 410). The actuator assembly 400 also includes one or more temperature sensors (shown as 420 on FIG. 2) located on or in proximity to the radiator 40.

When assembled in accordance with the present invention, such as shown in FIG. 17, the pivot pin portion 252 of the solid end cap 100 secured at the first end 80 of the hollow body portion 50 is inserted within an opening 306 of one frame section 302, while the respective pivot pin portion 252 of the solid end cap 110 secured at the second end 90 of the hollow body portion 50 is inserted within the respective paired opening 308 of the second frame section 304. Still further, the pin portion 250 of the solid end cap 100 at one end 80 of the hollow body portion 50 is secured to the link bar 410. Similarly, the pin portion 250 of the solid end cap 100 at one end 80 of the hollow body portion 50 of the next adjacent vane 30 is also coupled to the link bar 410. Optionally, the pin portion 250 of the solid end cap 110 secured to the second end 90 of the hollow body portion 50 is also coupled to a second link bar 410.

Once assembled, the active grille system 25 may be used to control the temperature of the radiator 40, and more specifically the temperature of the coolant (not shown) flowing through the radiator 40, to control the heating and cooling of the vehicle as desired. In general, the temperatures sensors 420 sense the temperature of the radiator 40 for the vehicle and send output signals to the control unit 415. The control unit 415 has internal logic which determines the desired temperature for the coolant (not shown) passing through the radiator 40 for the vehicle 20, and therein sends a control signal to the actuator 405 to move up or down, which in turn moves the link bars 410. The movement of the link bars 410 causes the active shutter vanes 30 coupled to the link bars 410 through the pin portions 250 to move up or down, therein causing the respective shutter vanes 30 to rotate clockwise or counterclockwise about an axis defined along the length of the pivot pin portions 252 in response.

More specifically, each one of the active shutter vanes 30 coupled to the link bar 410 rotates in a coordinated manner around a respective axis defined by a line L1 extending through the respective pair of openings 306, 308 and through the respective length of the pivot pin portions 252 of each of the solid end caps 100, 110 of a respective single shutter vane 30 of the active grille system 25. Accordingly, while the respective pivot pin portions 252 rotate about the line L1, they remain coupled within the respective paired and spaced openings 306 or 308 of the frame section 302, 304, and hence rotate the active shutter vanes 30 to the respective open position, closed position, or partially open position as described above to provide the desired level of air flow to the radiator 40.

The active shutter vanes 30 of the present invention, which include the afore-mentioned hollow body portion 50 and solid end caps 100, 110, offer many advantages in terms of manufacturing ease, reduced costs, and increased performance as compared with active shutter vanes having the same size and shape and formed as a single solid piece in an injection molding process. For example, the active shutter vanes 30 of the present invention have reduced weight as a result of the hollow body portion design. In addition, the hollow body portion design of the active shutter vanes 30 provides increased torsional strength (and in certain instances more than two times the torsional strength), and increased bending rigidity, as compared with active shutter vanes formed as a single solid plastic part of the same general design.

Still further, the use of an extrusion or pultrusion process to form the hollow body portion eliminates warpage that results from molding solid, one-piece body parts of the same general design.

Also, extruded or pultruded hollow body portions 50 can easily be cut to a desired length, thus reducing capital costs associated with tooling requirements to form each individually sized vane. Accordingly, in active grille systems in which multiple length active shutter vanes are desirable, there is not a need to create individually shaped cavity molds corresponding to each one of the different lengths, resulting in substantially reduced capital costs by being able to create each different length in a single extrusion or pultrusion.

The present invention has been described herein in an illustrative manner. It is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

1. An active grille system for use in a cooling system for a vehicle having a radiator, said active grille system comprising:
a frame portion; and
a plurality of active shutter vanes, each one of said plurality of active shutter vanes rotatably coupled to said frame portion and comprising:
a hollow body portion comprising a first plastic material, said hollow body portion having an inner wall portion and an outer wall portion extending between a first end and a second end, said inner wall portion defining at least one cavity extending from said first end to said second end, said inner wall portion and said outer wall portion defining a first edge at said first end and a second edge at said second end;
a first solid end cap secured to said first end of said hollow body portion; and
a second solid end cap secured to a second end of said hollow body portion, each of said first and second solid end caps comprising a second plastic material the same or different from said first plastic material.

2. The active grille system of claim 1 further comprising an actuator assembly coupled to said plurality of active shutter vanes, said actuator assembly coordinating the rotation of said plurality of active shutter vanes relative to said frame portion.

3. The system of claim 1, wherein said frame portion comprises a pair of frame sections spaced from each other, wherein said first solid end cap of each respective one of said plurality of active shutter vanes is rotatably coupled to one of said pair of frame sections and wherein said second solid end cap of each respective one of said plurality of active shutter vanes is rotatably coupled to an other one of said pair of frame sections.

4. The active grille system of claim 1, wherein said hollow body portion includes a pair of opposing inlet portions partially defining a channel extending from said outer wall portion to said inner wall portion.

5. The active grille system of claim 1, wherein said first solid end cap and said second solid end cap each include an inner projection having an outer surface,
wherein said outer surface of said inner projection of said first solid end cap is resiliently engaged to said inner wall portion within said at least one cavity at said first end, and
wherein said outer surface of said inner projection of said second solid end cap is resiliently engaged to said inner wall portion within said at least one cavity at said second end.

6. The active grille system of claim 1, wherein said first solid end cap and said second solid end cap each include an outer projection having an inner surface,
wherein said outer wall portion at said first end of said hollow body portion is resiliently engaged to said inner surface of said outer projection of said first solid end cap; and
wherein said outer wall portion at said second end of said hollow body portion is resiliently engaged to said inner surface of said outer projection of said second solid end cap.

7. The active grille system of claim 1, wherein said first solid end cap and said second solid end cap each have an edge surface,
wherein said edge surface of said first solid end cap is welded to said first edge; and
wherein said edge surface of said second solid end cap is welded to said second edge.

8. The active grille system of claim 1, wherein said first solid end cap and said second solid end cap each have an edge surface,
wherein said edge surface of said first solid end cap is secured to said first edge with a first adhesive; and
wherein said edge surface of said second solid end cap is secured to said second edge with a second adhesive, said second adhesive the same as or different from said first adhesive.

9. The active grille system of claim 1, wherein said at least one cavity comprises at least two cavities, and wherein said inner wall portion includes at least one rib portion extending from said first end to said second end, wherein each one of said at least one rib portion separates a first one of said at least two cavities from an adjacent one of said at least two cavities.

10. The active grille system of claim 1, wherein said first plastic material comprises a fiber-reinforced polymeric material including a polymeric material and a fiber material.

11. A method for forming an active shutter vane for use in an active grille system for a vehicle having a radiator, said method comprising
extruding or pultruding a hollow body portion from a first plastic material, the hollow body portion having an inner wall portion and an outer wall portion extending between a first end and a second end, the inner wall portion defining at least one cavity extending from the first end to the second end, the inner wall portion and the outer wall portion defining a first edge at the first end and a second edge at the second end;
forming a first solid end cap and a second solid end cap from a second material, the second material the same or different from the first plastic material;
securing the first solid end cap to the first end of the hollow body portion; and
securing the second solid end cap to the second end of the hollow body portion.

12. The method of claim 11, wherein the first and second solid end cap are formed by injection molding the second material.

13. The method of claim 11, wherein each of the first solid end cap and the second solid end cap includes an inner projection having an outer surface, and wherein the steps of securing to first solid end cap to the first end and securing the second solid end cap to the send end comprise the steps of:
introducing the inner projection of the first solid end cap within the at least one cavity such that the outer surface of the inner projection of the first solid end cap is resiliently engaged to the inner wall portion at the first end; and
introducing the inner projection of the second solid end cap within the at least one cavity such that the outer surface of the inner projection of the second solid end cap is resiliently engaged to the inner wall portion at the second end.

14. The method of claim 11, wherein each of the first solid end cap and the second solid end cap includes an outer projection having an inner surface, and wherein the steps of securing to first solid end cap to the first end and securing the second solid end cap to the send end comprise the steps of:
introducing the outer wall portion at the first end of the hollow body portion within the outer projection of the first solid end cap such that the outer wall portion is resiliently engaged to the inner surface of the outer projection of the first solid end cap; and
introducing the outer wall portion at the second end of the hollow body portion within the outer projection of the second solid end cap such that the outer wall portion is resiliently engaged to the inner surface of the outer projection of the second solid end cap.

15. The method of claim 11, wherein the first solid end cap and the second solid end cap each have an edge surface, and wherein the steps of securing to first solid end cap to the first end and securing the second solid end cap to the second end comprise the steps of:
sonic welding the edge surface of the first solid end cap to the first edge of the hollow body portion; and
sonic welding the edge surface of the second solid end cap to the second edge of the hollow body portion.

16. The method of claim 11, wherein each of the first solid end cap and the second solid end cap have an edge surface, and wherein the steps of securing to first solid end cap to the first end and securing the second solid end cap to the second end comprise the steps of:
friction welding the edge surface of the first solid end cap to the first edge of the hollow body portion; and
friction welding the edge surface of the second solid end cap to the second edge of the hollow body portion.

17. The method of claim 11, wherein each of the first solid end cap and the second solid end cap have an edge surface, and wherein the steps of securing to first solid end cap to the first end and securing the second solid end cap to the second end comprise the steps of:
applying a first adhesive to edge surface of the first solid end cap or to the first edge of the hollow body portion and pressing the edge surface of the first solid end cap to the first edge such that the first adhesive bonds to the edge surface of the first solid end cap and to the first edge; and
applying a second adhesive to edge surface of the second solid end cap or to the second edge of the hollow body portion and pressing the edge surface of the second solid end cap to the second edge such that the second adhesive bonds to the edge surface of the second solid end cap and to the second edge, the second adhesive the same or different from the first adhesive.

18. An active shutter vane formed in accordance with the method of claim 11.

19. A method for forming an active grille system for a vehicle having a radiator, said method comprising:
forming a plurality of active shutter vanes according to claim 11;
providing a frame portion comprising a pair of frame sections spaced from each other;
providing an actuator assembly;
coupling the first solid end cap of each one of the plurality of active shutter vanes to one of the pair of frame sections and coupling the second solid end cap of each one of the active shutter vanes to another one of the pair of frame sections such that each one of the plurality of active shutter vanes is adjacent to at least another one of the plurality of active shutter vanes between the pair of frame sections; and
coupling each of one of the plurality of active shutter vanes to the actuator assembly such that the actuator assembly controls and coordinates the rotation of each one of the plurality of active shutter vanes relative to the frame portion.

20. An active shutter vane system formed in accordance with the method of claim 19.
